(19) United States
(12) Patent Application Publication
(10) Pub. No.: US 2009/0166284 A1
(43) Pub. Date: Jul. 2, 2009

(54) Filter System

(76) Inventors: Dieter Theis, Mandelbachtal (DE); Thomas Schneider, Friedrichsthal (DE); Ralf Wnuk, Bexbach/Kleinottweiler (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/227,934

(22) PCT Filed: Jun. 27, 2007
(86) PCT No.: PCT/EP2007/005670

§ 371 Date: Dec. 3, 2008

(30) Foreign Application Priority Data
Jul. 28, 2006 (DE) 10 2006 034 942.3

(51) Int. Cl. B01D 29/11

(52) U.S. Cl. 210/418; 210/437

(57) ABSTRACT

Disclosed is a filter system with at least one filter element (1) that is arranged below the surface of a body of water, with a fluid to be cleaned that can flow from the inner fluid chamber (11) of the filter element to the exterior of the latter, and that is surrounded by the body of water on the exterior such that the cleaned fluid can be discharged into said water. The filter element (1) has a column-like shape defining a vertical axis and is immersed in the body of water with the vertical axis running essentially vertical. The exterior of the filter element is surrounded by a sheath (25) that forms a flow canal (29) for a vertical flow of the body of water between said sheath and the exterior of the filter element (1).

The invention relates to a filter system having at least one filter element which is intended for use in installations in which fluids arise which are to be released into a pertinent body of water and wherein, for reasons of water pollution control, it is necessary for the fluids to be cleaned before release. The measures necessary for this purpose are often difficult and expensive, especially when large amounts of fluids arise which, when released unpurified, could pollute the pertinent bodies of water.

A problem occurs to a marked degree in this respect in the operation of offshore installations, such as drilling platforms for oil and gas recovery. Larger amounts of sea water are used in these installations as flushing and/or cooling liquid or for other operating purposes and are then returned to the ocean. In this connection, it is prior art to install filter systems on the pertinent drilling platforms. Due to the spatial confinement of the drilling platforms, the amount of space required for these filter systems leads to a reduction of the working space of the platforms that is available for actual raw material production, which reduction is unfavorable both in terms of operation and also economy.

In view of these circumstances, the object of the invention is to make available a filter system which offers both operating and also economic advantages, especially when used in offshore installations.

According to the invention, this object is achieved by a filter system having the features of claim 1 in its entirety.

Accordingly, an important particularity of the invention consists in that it is an underwater system. From the outset, the filter system avoids reducing the installation space on the pertinent platform available above the surface of the water and avoids impeding operational processes. In that the system is lowered onto the bottom of the body of water on which the pertinent drilling platform is anchored, fluids such as quantities of flushing water which arise directly at the pertinent drill hole, are delivered over a short path into the filter system and need not be pumped up to the above-water part of the pertinent platform. A further significant reduction of the amount of energy necessary for operation of the filter system is achieved by there being filter elements which are made column-like according to the invention, which are immersed in the body of water with an essentially vertically running vertical axis, and which are surrounded on their exterior by a sheath which forms a flow channel for the vertical flow of the body of water surrounding the pertinent filter element. On the exterior of the filter element this yields a suction action which in turn leads to a reduction of the energy demand for the filtration process.

Especially advantageously, the arrangement in this instance can be such that the shape of the sheath and its positional relationship to the exterior of the respective filter element are chosen such that the sheath promotes vertical upward flow of the water in the flow channel. For this purpose, the sheath can form a type of chimney by whose action the cleaned fluid emerging on the exterior of the filter element is discharged toward the top, as a result of which favorable pressure conditions arise on the filter element and the filtration process can therefore take place when the pressure difference between the fouled side and the clean side has been reduced.

The chimney action is especially good when the inside wall of the sheath has a distance from the exterior of the filter element which changes over the length of the vertical axis such that the free cross section of the flow channel is reduced from a maximum value on the lower entry end of the flow channel to a minimum value on the upper exit end. Since, in this connection, the flow velocity in the flow channel increases toward the top, over the height of the filter element the change of the static pressure conditions promotes efficiency of the filtration process.

The filter system according to the invention can be made such that at least one filter element with its lower end is supported on a connection fitting which is connected to a fluid port which discharges the fluid to be cleaned by way of a controllable cut-off means.

In especially advantageous embodiments the arrangement is such that several connection fittings for the respective filter elements branch off from the fluid port. This yields the possibility of operating a correspondingly larger or smaller number of filter elements, depending on the amount of fluid to be cleaned which is formed, or in current operation the possibility of replacing the pertinent used (fouled) filter elements, while other filter elements continue to operate.

As already mentioned, a correspondingly chosen configuration of the flow channel promotes vertical flow on the pertinent filter element. For this purpose the arrangement can be made such that the sheath, proceeding from its lower end region which has a bell-like shape which is modeled on the bell of a trombone, extends essentially with a conical taper to its upper end. In this way, the flow channel on the lower entry end has a larger inlet cross section in the shape of a feed hopper, the sheath preferably with its upper end being suspended on the top end of the respective filter element while leaving a passage for the vertical flow, such that the lower end region of the sheath is offset to the top by a segment relative to the lower end of the filter element. This positional arrangement promotes the inflow of the surrounding water from the bottom end of the filter element into the flow channel.

As an extension of the flow channel which is formed by the sheath to the top, there can be a hood in the manner of a chimney hood on the top end of the sheath.

As an alternative to the “bell construction” in which each filter element is surrounded by a bell-like sheath, the filter system can be implemented in a “box construction.” Here the sheath is formed by the wall parts of a box containing a collecting space which forms a part of the fluid port and from which at least one connection fitting branches off.

In embodiments such as these, the arrangement is preferably such that the box has a lower box which is rectangular in outline, along whose side edges the collecting space extends, and which has an opening which is surrounded by the collecting space and on which an upper box which forms at least one flow channel for at least one filter element is attached.

In order to reduce the flow cross section of the respective flow channel toward the top, the upper box can have at least one side wall which, relative to the vertical axis, has a tilt which reduces the free cross section of the respective flow channel toward the top.

In the “box construction” the upper box can have two shafts which extend next to one another along the long sides of the lower box, assigned to each shaft there being several filter elements in a row, and in which their flow channels are separated by walls which run transversely to the side walls.

As filter elements for the filter system according to the invention, slit screen tube filter elements, as are known from DE 197 11 589 A1, have proven especially favorable. These filter elements are commercially available both in cylindrical and also in conical form. In conjunction with the flow channels which taper to the top and which are provided in the invention, for the filter system according to the invention, conical slit screen tube filter elements are especially suited which taper slightly conically to the top proceeding from the lower inlet end.

The subject matter of the invention is also a filter unit which is provided for the filter system according to the invention and which has the features of claim 15.

The invention is explained in detail below using the embodiments shown in the drawings.

FIG. 1 shows a schematically greatly simplified, and, with respect to the number of filter elements shown, incomplete side view of one embodiment of the filter system according to the invention with eight filter elements, each sheathed individually;

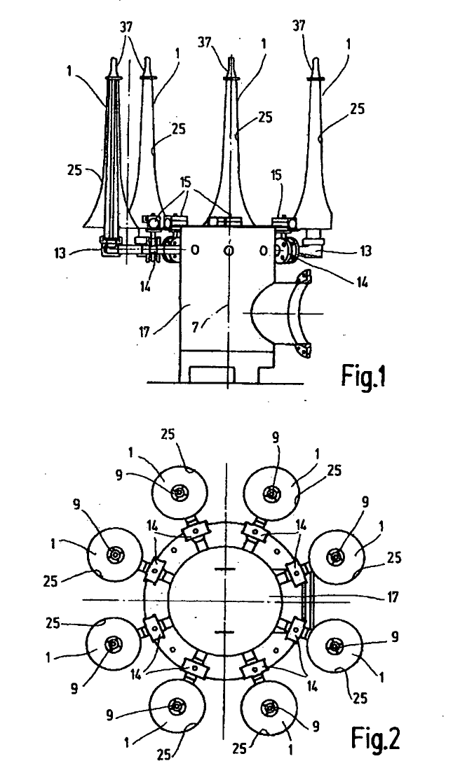

FIG. 2 shows a top view of FIG. 1, all filter elements being visible;

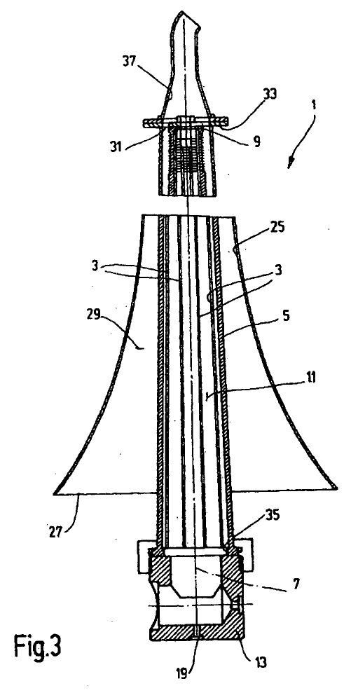

FIG. 3 shows a vertical section of one of the sheathed filter elements of the embodiment, shown greatly enlarged compared to FIGS. 1 and 2;

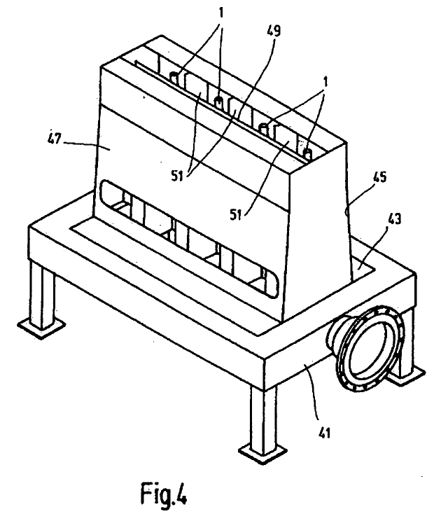

FIG. 4 shows a schematically greatly simplified perspective oblique view of a second embodiment of the filter system according to the invention;

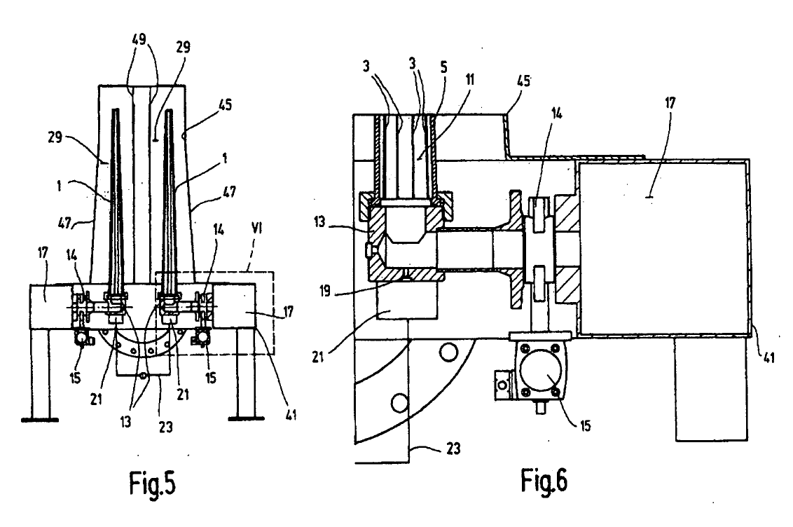

FIG. 5 shows a schematically greatly simplified cross section of the embodiment of FIG. 4, and

FIG. 6 shows a partial cross section of the region designated as VI in FIG. 5, enlarged approximately four-fold compared to FIG. 5.

FIGS. 1 to 3 show a first embodiment of the filter system with eight individually positioned filter elements 1, each sheathed separately, of which one is shown separately in FIG. 3. The filter elements 1 are slit screen tubular filter elements of slightly conical construction, the support rods 3 being wound with one or more layers of at least one wire profile 5 such that gaps are formed through which a fluid can pass. The wire profile 5, which is made of high-grade steel like the support rods 3, is at least in part connected permanently to the support rods 3, for example, by welding. In the slightly conical construction under consideration, the support rods 3 run slightly tilted to the vertical axis 7 to an upper sealing cover 9 which closes the inner fluid chamber 11 on the top end. For the inflow of the fluid which is to be cleaned, the lower, open end of the filter element is attached to a connection fitting 13. Each connection fitting 13 is connected, by way of one blocking gate means 14 which can be controlled by a pneumatic drive 15, to a fluid collecting space 17 from which, with the gate means 14 opened, the fluid to be cleaned is supplied to the respective filter element 1. Each connection fitting 13, as is clearly apparent of FIG. 3, has a compressed air inlet 19. FIGS. 5 and 6, which will be detailed in the description of the second embodiment, show (see in particular FIG. 6) that upstream from the inlets 19 on the connection fittings 13 a solenoid valve 21 is connected, by way of which compressed air can be blown into the fluid chamber 11 from a compressed air line 23.

As already mentioned, in the embodiment from FIGS. 1 to 3 each filter element 1 has its own sheath 25. As is best shown in FIG. 3, the sheath 25, which is made in one piece from high-grade steel, has an elongated bell-like shape, on the lower end 27 (FIG. 3) a feed hopper being formed which is shaped in the manner of the bell of a trombone. This feed hopper forms the start for a flow channel 29 for upward vertical flow of the body of water, into which the filter system is immersed. As is likewise shown clearly in FIG. 3, the sheath 25 extends at a distance from the exterior of the slit screen tube filter element such that the inside flow cross section of the flow channel 29 (FIG. 3) which has formed diminishes toward the top end 31. On this top end 31 the cross members 33 are screwed to the sealing cover 9, on which members the sheath 25 is suspended such that its lower end 27 is located at a distance above the connection fitting 13, the inlet region of the flow channel 29 therefore begins somewhat above the lower end 35 of the slit screen tube filter element. With the upper cross members 33 a hood 37 is formed which in the manner of a chimney hood forms a continuation of the flow channel 29. The lower end 27 of the sheath 25 viewed in cross section is at least three times as large as the cross section of the filter element 1 at this point and, viewed from the exterior, the sheath 25 is made convex with increasing curvature in the direction of the lower free end 27. On the top end 31 the sheath 25 viewed in cross section is approximately 1.5 times larger than the cross section of the filter element 1 in this region.

The second embodiment shown in FIGS. 4 to 6, in contrast to the example described first, constitutes a type of box construction, likewise there being eight filter elements which, however, are arranged not individually, but in two straight rows which run parallel to one another. In this embodiment a lower box 41 with a rectangular outline is mounted upright on the bottom of the body of water. The lower box 41 along its short and long sides forms the collecting space 17 for the fluid which is to be cleaned. In the central region surrounded by the collecting space 17 the lower box 41 has an opening 43 for the entry of the surrounding water, see FIG. 4. Above this opening 43 is an upper box 45 whose walls border the flow channels 29 (FIG. 5) for the vertical flow along the slit screen tube filter elements. As is apparent from FIGS. 4 and 5, the side walls 47 which form the longitudinal sides of the upper box 45 run slightly tilted to the vertical so that, as in the first embodiment, the inside flow cross section of the flow channels 29 is reduced toward the top. As mentioned, the filter elements 1 are arranged in two parallel rows which are separated from one another by partitions 49. Cross walls which run between the latter and the adjacent side wall 47 separate the sequence of flow channels 29 from one another. As can be seen from FIGS. 5 and 6, gate means 14 and connection fittings 13 of the filter elements each branch off from the regions of the collecting space 17 which extend along the longitudinal sides of the lower box 41.

Analogously to the first described example of the filter system, individual filter elements or a desired number of filter elements can be in operation, depending on the incidental amount of fluid. Likewise, as in the first described example, the filtration process and the formation of the vertical flow in the flow channels 29 can be promoted by blowing in compressed air via the inlet openings 19 via the connection fittings 13. The operating behavior both of the example made in the “box construction” and also the example made in the “bell construction” is essentially identical. However, in the construction from FIGS. 1 to 3, individual filter elements 1 can be individually replaced especially easily and conveniently under water as a complete function unit consisting of a slit screen tube filter element with a bell-shaped sheath and a hood located on its top end, compared to the embodiment from FIGS. 4 to 7 where the filter elements are less easily accessible within the upper box 45.

1. A filter system having at least one filter element (1) which is located below the surface of a body of water, through which the fluid to be cleaned can flow from its inner fluid chamber (11) to its exterior, and is surrounded on its exterior by the body of water so that fluid is released into the latter, the filter element (1) having a column-like shape which defines a vertical axis (7), being immersed in the body of water with an essentially vertically running vertical axis (7) and on its exterior being surrounded by a sheath (25) which forms a flow channel (29) for vertical flow of the water between the sheath and the exterior of the filter element (1).

2. The filter system according to claim 1, wherein the shape of the sheath (25) and its positional relationship to the exterior of the respective filter element (1) are chosen such that the sheath (25) promotes vertical upward flow of the water in the flow channel (29).

3. The filter system according to claim 2, wherein the inside wall of the sheath (25) has a distance from the exterior of the filter element (1) which changes over the length of the vertical axis (7) such that the free cross section of the flow channel (29) is reduced from a maximum value on the lower entry end of the flow channel (29) to a minimum value on the upper exit end.

4. The filter system according to claim 3, wherein at least one filter element (1) with its lower end (35) is supported on a connection fitting (13) which is connected to a fluid port (17) which discharges the fluid to be cleaned by way of a controllable cut-off means (14).

5. The filter system according to claim 4, wherein several connection fittings (13) for the respective filter elements (1) branch off from the fluid port (17).

6. The filter system according to claim 2, wherein the sheath (25), proceeding from its lower end region (27) which has a bell-like shape which is modeled on the bell of a trombone, extends essentially with a conical taper toward its upper end.

7. The filter system according to claim 6, wherein the sheath (25) with its upper end is suspended on the top end (31) of the respective filter element (1) while leaving a passage for the vertical flow such that the lower end region (27) of the sheath (25) is offset to the top by a segment relative to the lower end (35) of the filter element (1).

8. The filter system according to claim 6, wherein the bell-like bottom end region (27) of the sheath (25) on the end side has a diameter which corresponds at least to twice the diameter of the lower end (35) of the filter element (1).

9. The filter system according to claim 6, wherein there is a hood (37) which extends the flow channel (29) which is formed by the sheath (25) to the top in the manner of a chimney hood on the top end of the sheath (25).

10. The filter system according to claim 4, wherein the sheath (25) is formed by the wall parts (47, 49, 51) of a box (41, 45) which contains a collecting space (17) which forms a part of the fluid port and from which at least one connection fitting (13) branches off.

11. The filter system according to claim 10, wherein the box has a lower box (41) which is rectangular in outline, along whose side edges the collecting space (17) extends and which has an opening (43) which is surrounded by the collecting space (17) and on which an upper box (45) which forms at least one flow channel (29) for at least one filter element (1) is attached.

12. The filter system according to claim 11, wherein the upper box (45) has at least one side wall (47) which relative to the vertical axis (7) has a tilt which reduces the free cross section of the respective flow channel (29) toward the top.

13. The filter system according to claim 12, wherein the upper box (45) has two shafts which extend next to one another along the long sides of the lower box (4), in each of which shafts there are several filter elements (1) in a row, whose flow channels (29) are separated by walls (51) which run transversely to the side walls (47).

14. The filter system according to claim 1, wherein at least one filter element is a slit screen tube filter element (1).

15. A filter unit for a filter system according to claim 14, the slit screen tube filter element (1) and the bell-like sheath (25) which is connected to its top end (31), preferably including the hood (37) which is located on its top end, forming a prefabricated function unit which can be replaced in its entirety if necessary.
